(19) United States
(12) Patent Application Publication
(10) Pub. No.: US 2009/0115183 A1
(43) Pub. Date: May 7, 2009

(54) Clip for Fixing Line Type Bookmark

(76) Inventor: Mun-Chan Kim, Seoul (KR)

Correspondence Address: John W Renner;Renner Otto Boisselle & Skalar, 1621 Euclid Avenue 19th Floor, Cleveland, OH, 44115, US

(21) Appl. No.: 12/083,696

(22) PCT Filed: Sep. 22, 2006
(86) PCT No.: PCT/KR2006/003764

§ 371 Date: Apr. 15, 2008

(30) Foreign Application Priority Data
Oct. 25, 2005 (KR) 10-2005-0100849

(51) Int. Cl. B42D 9/00

(52) U.S. Cl. 281/42; 281/45

(57) ABSTRACT

The present invention provides a clip for holding a bookmark string to mark a place. The clip of the present invention includes a loop part (10), to which the bookmark string, to be placed between pages of the book, is knotted. The clip further includes an outer clip part (20), which extends a predetermined length from the loop part (10) and is supported on the outer surface of a binding part (B) of the book, and an inner clip part (30), which extends a predetermined length, greater than the length of the outer clip part (20), from the loop part (10) at a position spaced apart from the outer clip part (20) by a predetermined distance, and has a shape such that it approaches the outer clip part (20) from a proximal end thereof to a distal end thereof, and such that the distal end thereof is bent towards the outer clip part (20). Furthermore, the inner clip part (30) is elastically supported on the inner surface of the binding part of the book.

### TECHNICAL FIELD

The present invention relates, in general, to bookmarks and, more particularly, to a clip for holding a bookmark string which is constructed such that a process of removably coupling the bookmark string thereto is easily and conveniently conducted, so that the clip can be used for various books, and which can be reliably fastened to the book to prevent it from being lost.

### BACKGROUND ART

Generally, books are bound without bookmarks included therewith. Therefore, a page of a book is sometimes folded, or a separate bookmark having various advertisements is used to mark the place to which a user has read the book.

However, in the case where a page of the book is folded to mark the place, because the book is damaged, the appearance thereof is deteriorated. In the case where a simple bookmark made of a thick paper or coated paper is used, the bookmark may easily become lost, and is not noticeable.

Meanwhile, the bookmark is placed between the pages of a book to make it possible for a user to conveniently find the place to which the user has read the book. Depending on the kind of book, there are various kinds of bookmarks, for example, a slip type bookmark, a sticker type bookmark, a string type bookmark, a clip type bookmark, etc.

The slip type bookmark is not noticeable and is undesirably easily removed from a book. In the case of the sticker type bookmarker, because the adhesive force thereof is gradually reduced, it cannot be used for a long period. The string type bookmark provides a graceful appearance but is problematic in that the string can be worn and thus be severed.

Therefore, clip type bookmarks, which can be used in various kinds of books, are highly visible, and do not wear out easily, have been preferred. A conventional clip type bookmark has a U shape and includes elastic clip parts at opposite positions spaced apart from each other by a predetermined gap. Thus, the clip type bookmark is elastically fitted over a page of a book by inserting the page between the clip parts.

However, because the clip type bookmark is fitted over a page of the book, it may slide with respect to the page and thus be undesirably removed from the book. Furthermore, if the page of the book is relatively thin, the page may be damaged by scratches. In addition, the conventional clip type bookmark has a hard feeling and has a disadvantage that it cannot mark several pages at the same time.

### DISCLOSURE OF INVENTION

### Technical Problem

Accordingly, the present invention has been made keeping in mind the above problems occurring in the prior art, and an object of the present invention is to provide a clip for holding a bookmark string which is conveniently and removably mounted to a book, is not undesirably easily removed from a book, does not damage a page of the book, may mark several places at the same time, and has a graceful appearance.

### Technical Solution

In order to accomplish the above object, the present invention provides a clip for holding a bookmark string, the clip inserted into a book to mark a place of the book, and including: a loop part, to which the bookmark string to be placed between pages of the book is knotted, the loop part having a thin ring shape; an outer clip part extending a predetermined length from the loop part and supported on an outer surface of a binding part of the book; and an inner clip part extending a predetermined length greater than the length of the outer clip part from the loop part at a position spaced apart from the outer clip part by a predetermined distance and having a shape such that the distance between the inner clip part and the outer clip part decreases from a proximal end thereof to a distal end, and such that the distal end of the inner clip part is bent towards the outer clip part, the inner clip part being elastically supported on an inner surface of the binding part of the book.

Furthermore, the distal end of the inner clip part may have a saw-toothed shape.

The loop part, the outer clip part and the inner clip part may be integrally made of one selected from a wire, stainless steel, steel or synthetic resin.

The loop part, the outer clip part and the inner clip part may be made of synthetic resin, and an iron core may be embedded therein.

Preferably, a width of the outer clip part may be greater than a width of the inner clip part, and a surface of the outer clip part, which contacts the outer surface of the binding part of the book, may be planar.

### Advantageous Effects

The clip for holding a bookmark string according to the present invention is constructed such that a process of removably coupling the bookmark string thereto is easily and conveniently conducted and the coupled bookmark string is prevented from being undesirably removed from the clip, so that the clip can be used in various books and is prevented from being lost. Furthermore, the clip of the present invention does not damage the pages of the book, may mark several places at the same time, has a graceful appearance, and may have an advertising function.

Although preferred embodiments of the present invention will be disclosed for illustrative purposes, those skilled in the art will appreciate that various modifications, additions and substitutions are possible, without departing from the scope and spirit of the invention. Therefore, such modifications, additions and substitutions must be regarded as falling within the bounds of the accompanying claims.

### DESCRIPTION OF THE DRAWINGS

FIG. 1 is a perspective view of a clip for holding a bookmark string, according to an embodiment of the present invention;

FIG. 2 is a perspective view showing the bookmark string knotted to the clip according to the present invention;

FIG. 3 is a perspective view showing the use of the clip for holding the bookmark string according to the present invention;

FIGS. 4 through 6 are views showing clips for holding bookmark strings according to another embodiment of the present invention; and

FIGS. 7 through 9 are views showing clips for holding bookmark strings according to another embodiment of the present invention.

### BEST MODE FOR CARRYING OUT THE INVENTION

Hereinafter, preferred embodiments of the present invention will be described in detail with reference to the attached drawings.

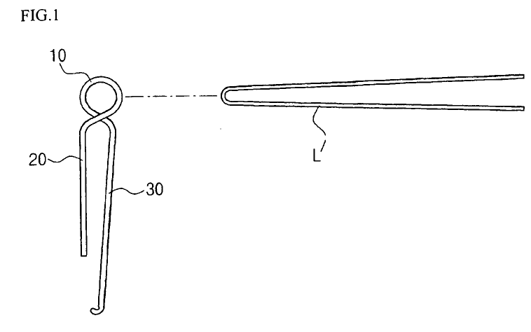

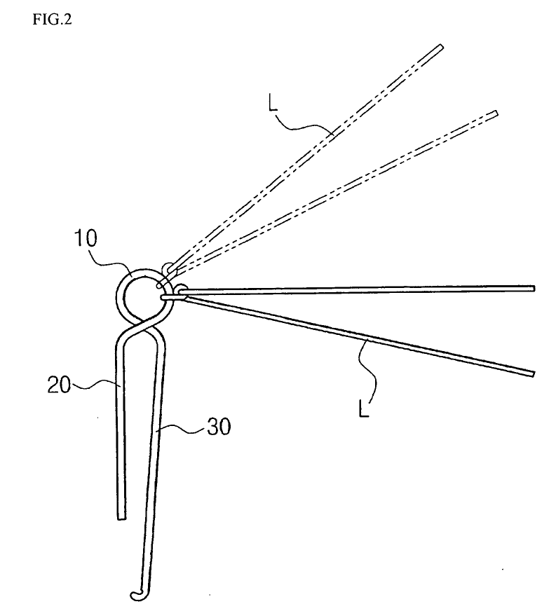

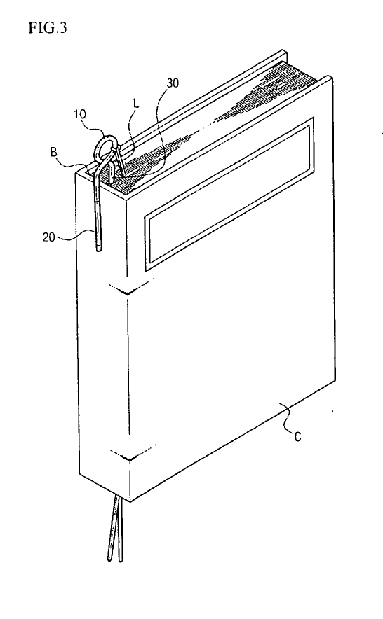

FIG. 1 is a perspective view of a clip for holding a bookmark string, according to the present invention. FIG. 2 is a perspective view showing the bookmark string knotted to the clip according to the present invention. FIG. 3 is a perspective view showing the use of the clip for holding the bookmark string according to the present invention.

As shown in FIGS. 1 through 3, the clip for holding the bookmark string according to the present invention has an approximate U shape and includes a loop part 10, an outer clip part 20 and an inner clip part 30.

The loop part 10 has a thin ring shape. At least one bookmark string L to be interposed between the pages of a book to mark a place is knotted to the loop part 10.

The outer clip part 20, which is brought into contact with and is supported on an outer surface of a binding part B of a book cover C, extends a predetermined length from the loop part 10.

The inner clip part 30 is brought into contact with, and is supported on an inner surface of, the binding part B. The inner clip part 30 extends a predetermined length from the loop part 10 at a position spaced apart from the outer clip part 20 by a predetermined distance (appropriate for insertion of the binding part B therebetween). Here, the inner clip part 30 extends a length greater than that of the outer clip part 20 such that it can be stably placed inside the binding part B.

Furthermore, to elastically fasten the inner clip part 30 to the inner surface of the binding part B, the inner clip part 30 extends the predetermined length to have a shape such that it approaches the outer clip part 20 from the proximal end thereof to the distal end thereof. In addition, the distal end of the inner clip part 30 is perpendicularly bent towards the outer clip part 20 to ensure fastening force using friction.

As shown in an embodiment of FIGS. 1 through 3, in the case where the loop Part 10, the outer clip part 20 and the inner clip part 30 are formed using a wire, the loop part 10 is formed by bending the wire at 360°, and the distal end of the inner clip part 30 is thereafter bent towards the outer clip part 20.

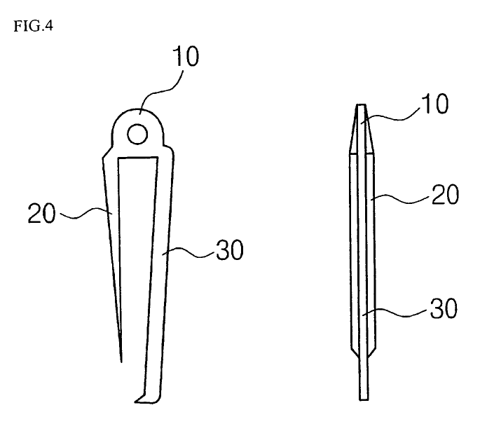

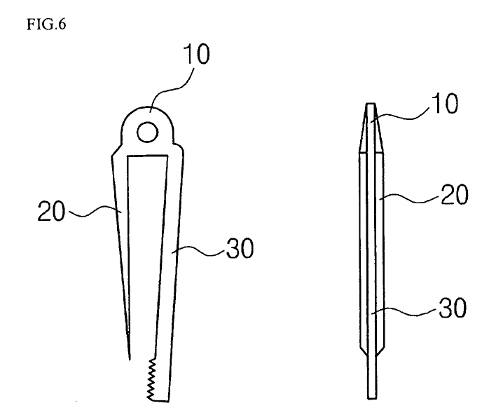

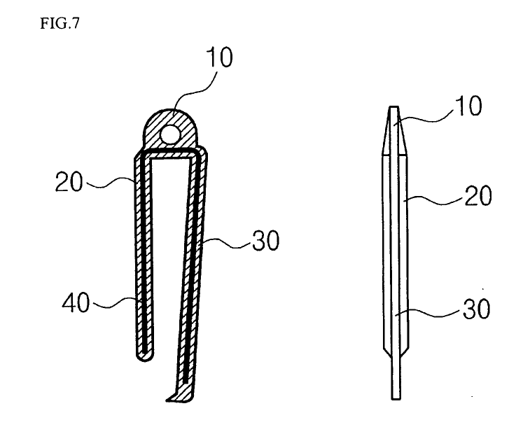

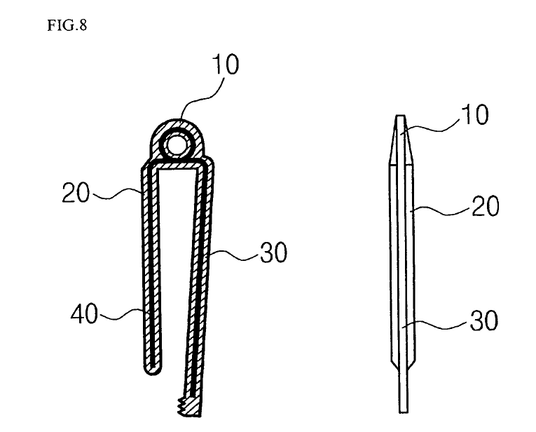

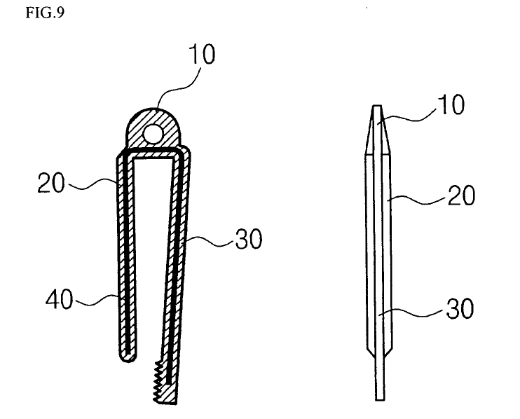

FIGS. 4 through 6 are views (a front view and a right side view) showing clips for holding bookmark strings according to another embodiment of the present invention. FIGS. 7 through 9 are views (front sectional views and right side views) showing clips for holding bookmark strings according to another embodiment the present invention.

In the embodiment shown in FIGS. 4 through 9, a loop part 10, an outer clip part 20 and an inner clip part 30 may be integrally made of stainless steel, steel or synthetic resin such that the clip can be easily manufactured and have appropriate elasticity.

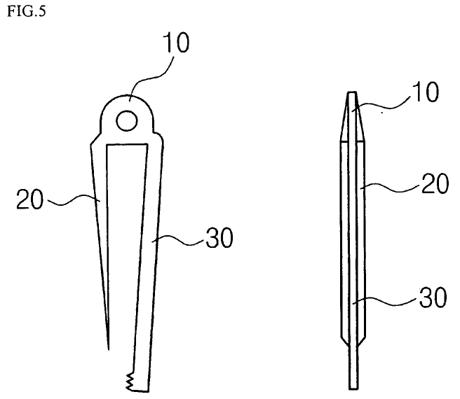

In this case, the bent distal end of the inner clip part 30 may be formed into various saw-toothed shapes (see, FIGS. 5, 6, 8 and 9) to have high frictional force.

Meanwhile, in the case where the loop part 10, the outer clip part 20 and the inner clip part 30 are made of synthetic resin, as shown in the embodiments of FIGS. 7 through 9, an iron core 40 may be embedded in the clip to reinforce the durability and elasticity of the clip.

Preferably, as shown in the right side view of each drawing, the width of the outer clip part 20 is slightly greater than that of the inner clip part 30, such that the outer clip part 20 can be stably supported on the outer surface of the binding part B. Furthermore, it is preferable that the portion of the outer clip part 20 that contacts the outer surface of the binding part B be completely planar.

The operation of the bookmark string holding clip of the present invention having the above-mentioned construction will be explained herein below.

To mount the clip for holding the bookmark string, as shown in FIGS. 1 through 3, the bookmark string L is knotted to the loop part 10 and, thereafter, a user holds the loop part 10 using his/her hand and fits it over the upper end of the binding part B of the book cover C such that the outer clip part 20 and the inner clip part B are disposed on the opposite surfaces of the binding part B.

Then, the outer clip part 20 contacts and is supported on the outer surface of the binding part B, while the inner clip part 30 elastically contacts and is thus reliably supported on the inner surface of the binding part B. Therefore, the clip is prevented from being undesirably removed from the book, and the above process can be conducted without damaging the pages of the book. The bookmark string L is placed between desired pages, and an end thereof is exposed outside the lower end of the book.

Here, because the loop part 10 is exposed outside the upper end of the book so that the user is able to easily hold the clip, processes of mounting or removing the clip to or from the book can be conveniently conducted. Furthermore, several bookmark strings L may be tied to the loop part 10. In this case, several places in the book can be marked at the same time. In addition, the clip of the present invention has a graceful appearance.

As well, because the width of the outer clip part 20 is greater than that of the inner clip part 30 and the portion of the outer clip part 20 that contacts the outer surface of the binding part B is completely planar, the outer clip part 20 can stably contact and be reliably supported on the outer surface of the binding part B.

Because the inner clip part 30, which extends the predetermined length, has a shape such that the distance between it and the outer clip part 20 gradually decreases from the proximal end thereof to the distal end, and because the distal end of the inner clip part 30 is bent towards the outer clip part 20, the inner clip part 30 can be elastically supported on the inner surface of the binding part B and reliably maintain the fastening force using friction, thus preventing the clip from becoming lost.

Meanwhile, in the case where the loop part 10, the outer clip part 20 and the inner clip part 30 are made of stainless steel, steel or synthetic resin, and the bent distal end of the inner clip part 30 has a saw-toothed shape (see, FIGS. 5, 6, 8 and 9), the clip can have higher elasticity and frictional force.

Moreover, in the case where the loop part 10, the outer clip part 20 and the inner clip part 30 are made of synthetic resin, as shown in FIGS. 7 through 9, if the iron core 40 is embedded in the clip, the durability and elasticity of the clip are further increased.

When it is desired to use the bookmark string holding clip of the present invention in another book, the user holds the loop part 10 and pulls it upwards with force that overcomes the elastic force and frictional force of the inner clip part 30. Then, the clip is easily removed from the book. If the end of the bookmark string L is worn, so that the appearance thereof is poor, the bookmark string L can be untied from the loop part 10 and easily replaced with a new one.

Furthermore, if various promotional objects having advertisements along with the bookmark string are coupled to the loop part 10, various products can be easily advertised while the bookmark is used.

1. A clip for holding a bookmark string, the clip inserted into a book to mark a place of the book, and comprising:
a loop part, to which the bookmark string to be placed between pages of the book is knotted, the loop part having a thin ring shape;
an outer clip part extending a predetermined length from the loop part and supported on an outer surface of a binding part of the book; and
an inner clip part extending a predetermined length greater than the length of the outer clip part from the loop part at a position spaced apart from the outer clip part by a predetermined distance and having a shape such that the distance between the inner clip part and the outer clip part decreases from a proximal end thereof to a distal end, and such that the distal end of the inner clip part is bent towards the outer clip part, the inner clip part being elastically supported on an inner surface of the binding part of the book.

2. The clip for holding the bookmark string according to claim 1, wherein the distal end of the inner clip part has a saw-toothed shape.

3. The clip for holding the bookmark string according to claim 1, wherein the loop part, the outer clip part and the inner clip part are integrally made of one selected from a wire, stainless steel, steel or synthetic resin.

4. The clip for holding the bookmark string according to claim 3, wherein the loop part, the outer clip part and the inner clip part are made of synthetic resin, and an iron core is embedded therein.

5. The clip for holding the bookmark string according to claim 4, wherein a width of the outer clip part is greater than a width of the inner clip part, and a surface of the outer clip part, which contacts the outer surface of the binding part of the book, is planar.

6. The clip for holding the bookmark string according to claim 2, wherein the loop part, the outer clip part and the inner clip part are integrally made of one selected from a wire, stainless steel, steel or synthetic resin.

7. The clip for holding the bookmark string according to claim 6, wherein the loop part, the outer clip part and the inner clip part are made of synthetic resin, and an iron core is embedded therein.

8. The clip for holding the bookmark string according to claim 7, wherein a width of the outer clip part is greater than a width of the inner clip part, and a surface of the outer clip part, which contacts the outer surface of the binding part of the book, is planar.
